(19) United States
(12) Patent Application Publication
(10) Pub. No.: US 2015/0127177 A1
(43) Pub. Date: May 7, 2015

(54) SIMULATED RAIN WITH DYNAMICALLY CONTROLLED DRY REGIONS

(71) Applicant: Keith H. Rothman, Commack, NY (US)

(72) Inventors: Keith H. Rothman, Commack, NY (US); John V. Mizzi, Poughkeepsie, NY (US)

(73) Assignee: Keith H. Rothman, Commack, NY (US)

(21) Appl. No.: 14/070,173

(22) Filed: Nov. 1, 2013

(51) Int. Cl. G05D 7/06

(52) U.S. Cl. CPC G05D 7/0629
USPC 700/283

(57) ABSTRACT

A simulated rain enclosure includes a ceiling supporting a tightly packed two dimensional array of water ejecting ceiling tiles having a direct presence detector associated with each ceiling tile. Detection of one or more persons under one or more said water tiles by the direct presence detectors turns off water flow from each associated ceiling tile and to a defined region of the ceiling tiles adjacent to each associated ceiling tiles. Water flow is returned from any ceiling tile previously turned off but not currently in a defined region.

### FIELD OF THE INVENTION

The present invention relates to simulated rain environmental enclosures with dynamically controlled dry regions.

### BACKGROUND OF THE INVENTION

In 2012 at the Barbican in London the genius concept of artist Hannes Koch for the Rain Room was manifest as a large intricate high-art participatory exhibit. The Rain Room was so popular with the Londoners that queues for the exhibit often exceeded six hours. In 2013, an expanded version of Rain Room was set up at the Museum of Modern Art (MOMA) in New York City; it ran for a two month period with equal popularity marked by queuing on the last day exceeding nine hours.

Rain Room was designed by England's Random International with copious help from high tech consulting firm 2M Engineering. Publications such as Digital Trends and the New York Times as well as releases on web sites of Random International and 2M offered some technical details of Rain Room. The objective of Rain Room is to allow visitors to enter a downpour of rain and roam at will without getting wet; their presence controls the rain to spare them.

These are some of the details that are in the public domain. MOMA cautioned visitors that it is possible to get slightly wet in the Rain Room, and that one should proceed slowly. The project took three years to perfect and depends on the simulated rain drops having to descend uniformly straight down. The cost of the installation is hinted by the fact that the MOMA exhibit was a joint partnership between MOMA and VW of America. The key to the design is a number of 3D camera sensors installed across the dark room. (3D cameras using the photonic mixing device principal based on time of flight distance measurement are available from IFM Corporation. By intense calculation using shape recognition to pinpoint Rain Room visitors and triangulation of vectors from multiple cameras, the approximate location under the various rain valves can be derived. Perhaps some variation of this technique was used.) The revolutionary control system uses a fast programmable logic controller (powerful computer) to take information from the cameras, and mapping software to decode the data and decide which of 1600 water valves to open and close at the appropriate times. To support the incredibly high speed communications while limiting cables and connectors, high speed Ethernet links insuring “updates every 6 milliseconds” were used. The Rain Room can handle up to ten visitors at a time and visitors are surrounded by a dry region of approximately a five foot radius. 260 gallons of water per minute are pumped from below the perforated floor to the ceiling to produce the simulated rain. In all, 660 gallons of water are circulated.

### OBJECTS OF THE INVENTION

The objective of this invention is to duplicate much of the magical environment of Rain Room for entertainment as well as museum venues. Most of the installations envisioned will be short runs such as state or county fairs or even local festivals often sponsored by local church parishes or fire house districts. Efficiency in set-up and tear-down is paramount as is ease of transportability. Also important are reliability, maintainability, and reparability “on the road”. For these reasons a different approach to the control technology has been taken.

Other objects will become apparent from the following description of the present invention.

### SUMMARY OF THE INVENTION

In keeping with these objects and others which may become apparent, the control system of this invention relies on direct presence detection of visitors as opposed to calculated locations of visitors within the simulated rain (SR) environment. In the first embodiment, a floor array of sensor tiles directly senses a visitor and locates him or her with respect to the water tiles above. In an alternate embodiment, the direct presence detection is co-located with the water tiles; this offers great conceptual simplification while presenting some design challenges. Either embodiment is compatible with the objectives of the last paragraph. Although sizes may vary, a very modular approach with many identical field replaceable units (FRU's) of preferably 10″ by 10″ tiles consolidated into 40″ by 40″ panels is used in both embodiments. Panels are designed to be easily handled by a single person, while extra FRU's can be easily carried for replacement in case of problems encountered while at an installation.

In the first embodiment, although sizes may vary, the SR floor is covered with preferably 10″ by 10″ floor tiles in registration with 10″ by 10″ water tiles directly above at ceiling level (13 foot height). The floor tiles are perforated to allow “rain” water to flow through into the holding area below. Each of the tiles incorporates a direct presence person sensor, such as a weight sensing element. This optionally can be as simple as a snap action switch, but a strain gauge or force sensing resistor is preferable due to faster action and no tactile feedback which might be felt by some people through their feet. So the direct presence detection is formed by sensing the force above an appropriate threshold (such as, for example, five pounds) produced by a foot on a tile. As floor tiles can be bridged by a foot, more than one tile may be triggered. A single person will trigger from one to four floor tiles simultaneously as he or she walks or stands inside the SR room. In this first embodiment, the floor tile array is polled by a computer on a regular basis to ascertain the locations of the triggered tiles. The coordinates of the triggered tiles (at last polling) are placed in a detected list. Each coordinate address entry of the detected list is then used to address the contents of a region table which contains the addresses of the tiles in a contiguous region around the detected tile location (approximately a 3 foot radius, although size may vary); these coordinates would have been previously entered for every tile location. These coordinates are appended to a turnoff list for each detected tile. After the detected tiles are serviced, the turnoff list is compacted by removing duplicate coordinates. Then the turnoff list is used to turn off all of the valves, such as solenoid valves, in the list corresponding to the dry regions around each of the detected floor tiles. The computer does this by a command signal to selected dry region valves. The solenoid valves are normally open; the only overt command action required is to turn a valve off. The “normal” state of a solenoid valve is ON or passing “rain” water through a water tile. Each OFF valve will turn itself ON again after a time delay unless re-triggered before the expiration of the delay period. Although the control flow above may sound formidable, it is a far cry from computational load required to handle pixel traffic from multiple 3D camera sensors as well as calculations to estimate the location of visitors as in the Rain Room. In fact, a high end laptop computer, for example, with an Intel 17 Core processor with 4 cores, 2.6 GHz clock, and 6 MB on-board cache is equal to the task at a very modest price. Since laptops sometimes crash, even if we were to treat SR Room as “mission critical” and use three computers running simultaneously with a “majority vote” protocol as the military developed decades ago, the cost of the computers would still be a small percentage of the total cost of an SR Room.

The sensor floor tiles are assembled into square panels of 16 tiles in a 4 by 4 array, although other quantities and sizes of tiles may vary. The floor tiles plug into each other within a panel and into adjacent panels at the periphery. The M and N orthogonal address lines are carried through each floor tile as is the power supplied. Care must be given to insure that the signal lines are waterproofed. The entry to the SR floor is handled in a natural fashion by appending an extra panel (such as, for example, 16 floor tiles) at the edge extending the number of rows by four at a single column location in the floor array. This panel then extends beyond the water tile edge, but as a person walks on it toward the SR floor, a dry region starts forming even before the person reaches the edge of the SR floor. Once a floor tile is addressed, the return data is a “1” if the tile is directly detecting a person's presence. To save connectors and wiring, this data is preferably returned to the computer on one of the two orthogonal address busses in a time multiplexed fashion.

One design parameter is the maximum allowable walking speed for a visitor to insure that the dry zone prevents wetting. This has been selected as 6 feet per second which corresponds to a brisk walking speed (approximately 4 miles per hour). Obviously other limits can be adopted, but this parameter is interrelated with the dry radius zone around each visitor which has been set at approximately 3 feet. These design parameters are also related to the approximate time it takes for a “raindrop” exiting a nozzle at a ceiling water tile to fall to the floor (estimated as 260 MS or 1.6 feet of walking distance at 6′ per second).

Each ceiling water tile houses its own solenoid valve and “showerhead”, preferably in the form of a hollow torus with a plurality of exit nozzles, such as nine exit nozzles, for the “rain”. Each ceiling water tile plugs into a preferably 40″ by 40″ panel which carries connections, such as two address bus connections, at each tile site along with water inlet and electrical power. Water is carried by suitable conduits, such as, for example, PVC distribution pipes attached to the top of each panel and feeding a row of four tiles each.

Water for the SR room must be filtered and treated to prevent bacterial or viral pathogenic growth. Chemical water treatment is to be avoided for this environment; better approaches involve UV radiation or ozone treatment. Assuming a pumping rate of between about 200 and about 300 gallons per minute, this would require 6 to 12 HP of pumping power. A single large pump of this size is rather difficult to set up and is quite heavy; it also does not lend itself to balanced water distribution over a 35′ by 35′ SR room area (or whatever the size and shape configuration may be). It is suggested that preferably four separate filter/water treatment modules be used, each with its own water pump, preferably with a capacity, such as at between 50 to 75 gallons per minute capacity. It could feed water to the SR room in a balanced fashion via manifolds, such as, for example, two manifolds where one manifold is placed at opposite sides of the room. If budgets permit, an extra reserve filter/treatment module and pump can be shipped with a SR room for quick field exchange in case of problems.

The alternate embodiment of SR Room also depends on direct presence detection, but it departs from use of a central computer (or any computer) for operation by adopting a local distributed control scheme. This is enabled by co-locating the direct presence detectors with each ceiling water tile. The SR floor is now just a passive perforated floor of any serviceable construction that permits “rain” water to fall through below. Another advantage of this approach is to remove the sensors used and any wiring from a directly wet environment. Since the control is governed by a sensor on each water tile affecting the “rain” exclusion zone around itself, failures also tend to be local and are very resistant to propagation to the far reaches of the SR Room. The direct presence detector associated with each ceiling water tile has a sensor preferably located in the center of the water emitting torus and facing straight down to detect the presence of a visitor directly below.

In the alternate embodiment, the presence detector signals the solenoid driver of the associated tile to stop the valve from supplying water to the multiple nozzles of the tile (turn valve OFF) while also starting a low powered transmitter to wirelessly signal adjacent tiles in the intended dry zone to turn their own solenoid valves OFF. Each ceiling water tile also has a receiver to receive these local signals from any transmitting tile in the vicinity. After the person is no longer under the particular tile, the condition is sensed and the transmitter is turned off as is the signal to the solenoid driver unless (as intended) the tile receiver is now receiving a signal from another tile in the vicinity (within the exclusion dry zone of another tile detecting the moved visitor). Eventually, when the visitor is outside the dry zone range of any tile, that tile will cease receiving a transmitted signal from any tile and the solenoid driver will shut down permitting the solenoid valve to turn itself ON again. This entire control sequence is achieved locally without the intervention of a central computer. All water tiles are identical and anonymous having no known “coordinate addresses” as to location on the SR floor. The key to operability of this scheme is the ability to have a transmitter on each tile that has a weak signal only receivable above a triggering threshold by another tile within the intended dry zone and not beyond. Efforts to achieve this will be discussed. While this embodiment lacks the precision of a “table lookup” of the previous embodiment in determining the tiles to be shut OFF, it may still rival the estimated locating precision of a scheme based on 3D camera use. If the intended radius of a dry zone is set at 3 to 4 feet, for example, and it occasionally deviates slightly at times and in different locations, the wet boundary may become closer to or farther away from a visitor; note that people are self-adaptive and would automatically tend to slow down if they are close to getting wet or speed up if the dry zone permits.

Note that the wireless signals selected may be signals, such as, for example, infrared (IR) (as in TV remote controls), radio frequency (RF) such as low power Bluetooth, or ultrasonic (US). The emitted signal can be shaped somewhat by a designed reflector to redirect the signal to achieve sharper drop off at the edge of the desired dry zone. Another aspect of controlling the radiation range of a transmitter is to control its power. This has traditionally been handled by a controller, such as an automatic gain control (AGC) of the output amplifier and careful voltage control. By using a simple on-board AGC receiver on each tile, the actual radiated signal is sampled to regulate the transmitter in true feedback control fashion.

A final signaling technique among ceiling water tiles in this embodiment preferably involves one or more signaling techniques, such as Dual-Mode transmission and reception whereby the signal is transmitted as both an IR or RF signal as well as a separate US signal. Note that the ultrasound transmission travels at the speed of sound which is several orders of magnitude slower than the IR or RF signal which propagates at close to the speed of light. By transmitting both signals at a higher level to insure reception at the edge of the intended dry zone (perhaps 6 feet), if the signals were both modulated by a pulse simultaneously at the source, the difference in time reception of the pulse from each mode by a receiving tile can be used to accurately gauge the distance from the source. If the received pulses from the preferably two modes differ in time less than a threshold determined by the dry zone radius, the solenoid valve of the receiving tile is turned off.

The same design of water system as for the first embodiment is compatible with this alternate embodiment.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a high level block diagram of the control system of the prior art Rain Room.

FIG. 2 is a high level block diagram of the control system of the first embodiment of the present invention.

FIG. 3 is a plan view of the sensor tile floor showing a dry zone pattern.

FIG. 4 is a diagram showing the address and data lines of the sensor floor as interfacing to the computer.

FIG. 5 is a high level wiring diagram of a single sensor floor tile.

FIG. 6 is a timing diagram showing pulse widths and relative timing of signals of a sensor tile floor.

FIG. 7 is a high level wiring diagram of a ceiling water tile.

FIG. 8 is a flow chart describing the control scheme of the first embodiment of the present invention.

FIG. 9 is a plan view of a sensor floor configured as sensor floor panels and including an entry floor panel.

FIG. 10 is a perspective view of a single sensor floor tile with direct presence detector embedded.

FIG. 11 is a plan view of the down facing surface of a ceiling water tile.

FIG. 12 is a side elevation of the ceiling water tile of FIG. 11.

FIG. 13 is a plan view of a down facing ceiling panel with only one of 16 sites populated with an attached ceiling water tile.

FIG. 14 is a plan view of the upward facing ceiling panel showing four segments of attached water distribution pipes.

FIG. 15 is a perspective view of a plan for a balanced water distribution system for the SR room of either embodiment.

FIG. 16 is a block diagram of the control system for a single ceiling water tile of the second embodiment of this invention.

FIG. 17 is a detail wiring diagram of the solenoid driver block of FIG. 16 including features for fast turn-on and delayed turn-off.

FIG. 18 is a flow chart explaining the operation of the control system for each of the ceiling water tiles of the second embodiment.

FIG. 19 is a side representation of the transmitted signal coverage as modified by the use of a reflector.

FIG. 20 is a block diagram showing the use of a signal sampling AGC receiver to control transmitter output.

FIG. 21 is a block diagram of a Dual-Mode transmitter with modulation.

FIG. 22 is a block diagram of a Dual-Mode receiver with timer and comparator.

FIG. 23 is a plan view of the down facing surface of a ceiling water tile of the second embodiment.

FIG. 24 is a side elevation of the water ceiling tile of FIG. 23.

FIG. 25 is a plan detail of a portion of the down facing surface of an unpopulated ceiling water tile panel for the second embodiment of this invention.

### DETAILED DESCRIPTION OF THE INVENTION

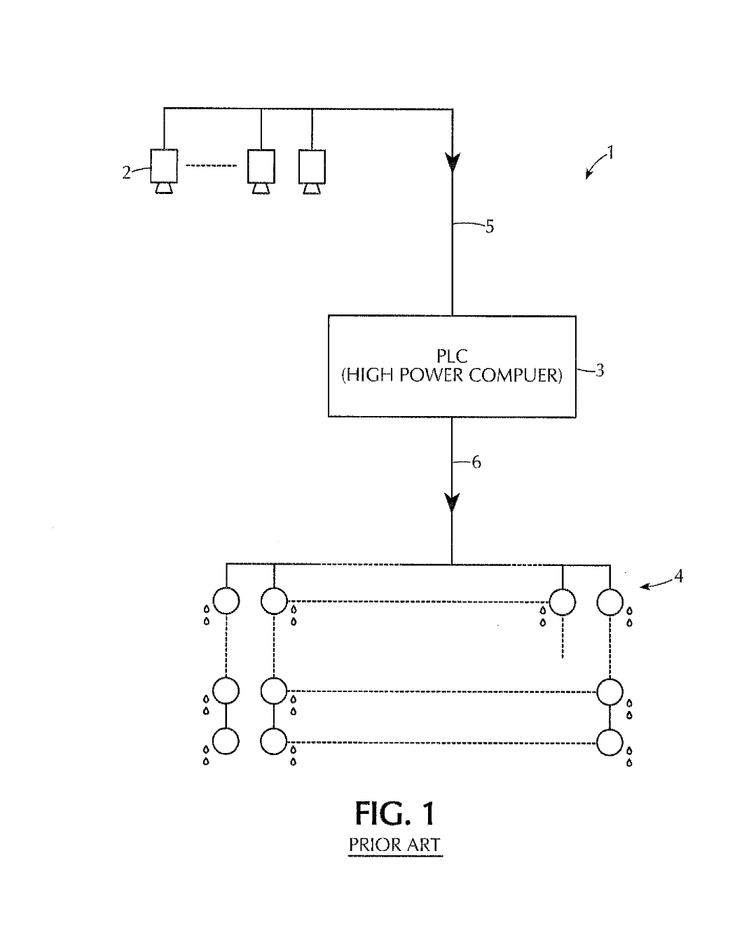

FIG. 1 shows a high level block diagram of the Rain Room 1 of the prior art. It shows a number of 3D camera sensors 2 connected via high speed Ethernet 5 to a high speed programmable logic controller (PLC) or high powered computer 3. PLC 3 controls an array of ceiling water tiles 4 via Ethernet cable 6. As per public information from the design company, both on and off commands are sent to the solenoid valves in ceiling 4 at appropriate times to maintain desired dry zones around the meandering visitors on the Rain Room floor.

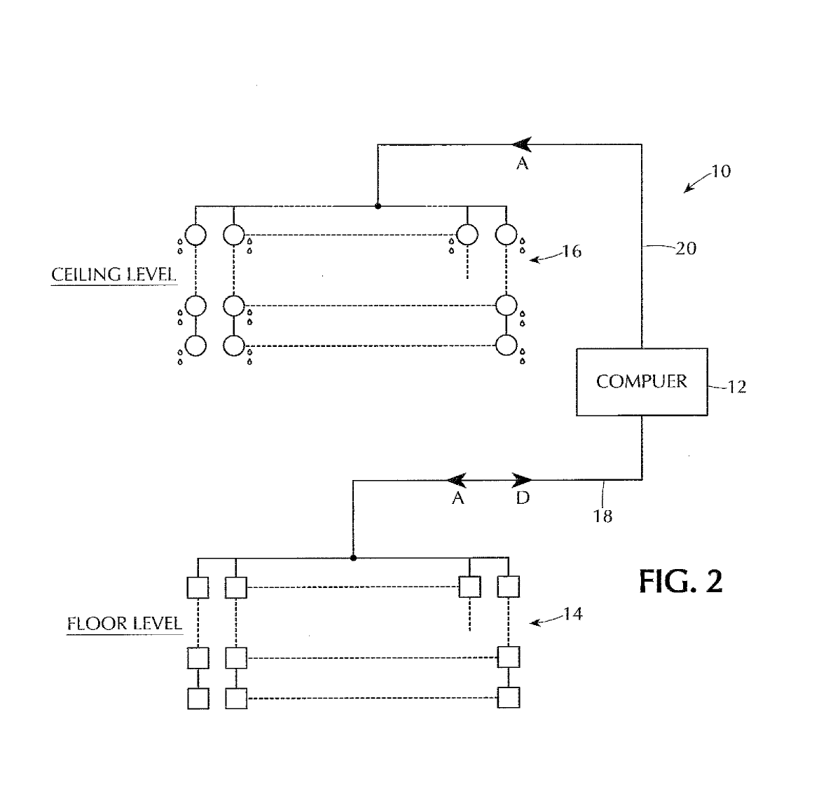

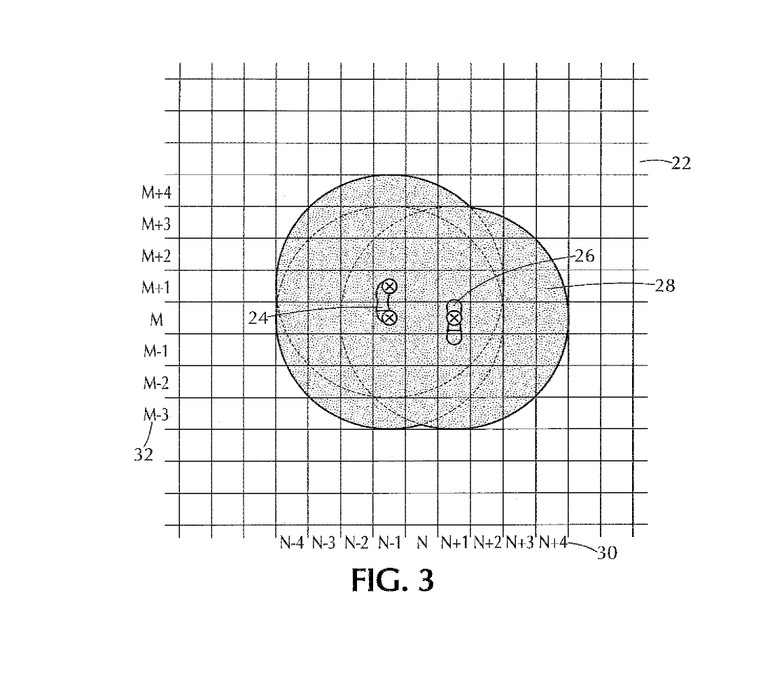

FIG. 2 shows a high level block diagram of the first embodiment of the present invention of an SR enclosure 10 with dynamically controlled dry regions around visitors within. An array of ceiling water tiles 16 is in direct registration with an array of equal sized sensor floor tiles 14 below. A high end laptop computer 12 accepts direct presence detection data from floor tiles sensing the weight of a person walking or standing atop via address and data bus 18. This data is used by computer 12 to control the turning off of normally open solenoid valves embedded in each ceiling tile of array 16 at the proper time and duration via ceiling water tile address bus 20 to maintain a dry zone around each sensor floor tile detecting a visitor's weight force. This situation is described in FIG. 3 by the detail of a section of sensor floor tiles addressed by row 32 M coordinates and column 30 N coordinates. The two foot prints 24 and 26 of a single visitor are shown on the tiles 22. Note that left foot 24 straddles two sensor tiles while the right foot 26 only bears down on a single tile. Since the water exclusion (dry) zone is determined around each individual floor tile 22 which senses a force as a circular of fixed radius there is much overlap around the three separate exclusion zones as shown to form single dry zone 28. Obviously if a family group were standing close to each other, there would be a single larger dry zone around the entire group maintaining a dry buffer zone at the periphery around the entire group. Thus, the control problem solved is to have computer 12 poll each of the sensor floor tiles 22 in array 14 to locate all direct presence locations, draw a virtual dry zone around each, and then use the addresses of each tile within a dry zone location to address the appropriate corresponding ceiling tile in array 16 to turn off the solenoid valve. A tile address more than 50% within the virtual dry zone is included while those less than 50% within the zone are excluded.

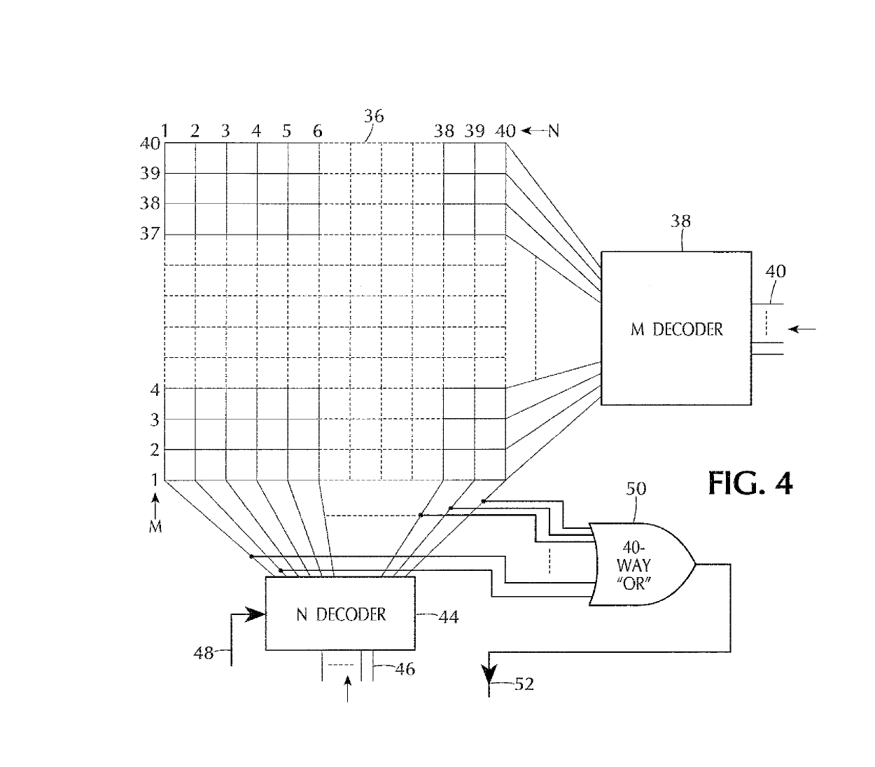

Although size and shape of an SR room may vary, this invention will be described using a square configurations of 10″ by 10″ tiles in a 40 row by 40 column configuration 36 as shown in FIG. 4. Using two 6-bit address busses 40 and 46 to address the M and N coordinates respectively from computer 12, each of the 1600 sensor floor tiles can be queried via M decoder 38 and N decoder 44. To save wiring, the N address busses are time multiplexed and used to return each data bit from each sensing floor tile via 40-way OR 50. N decoder 44 has tri-state output line drivers which are controlled into the high impedance state via inhibit line 48 from computer 12 during the time reserved for data transfer.

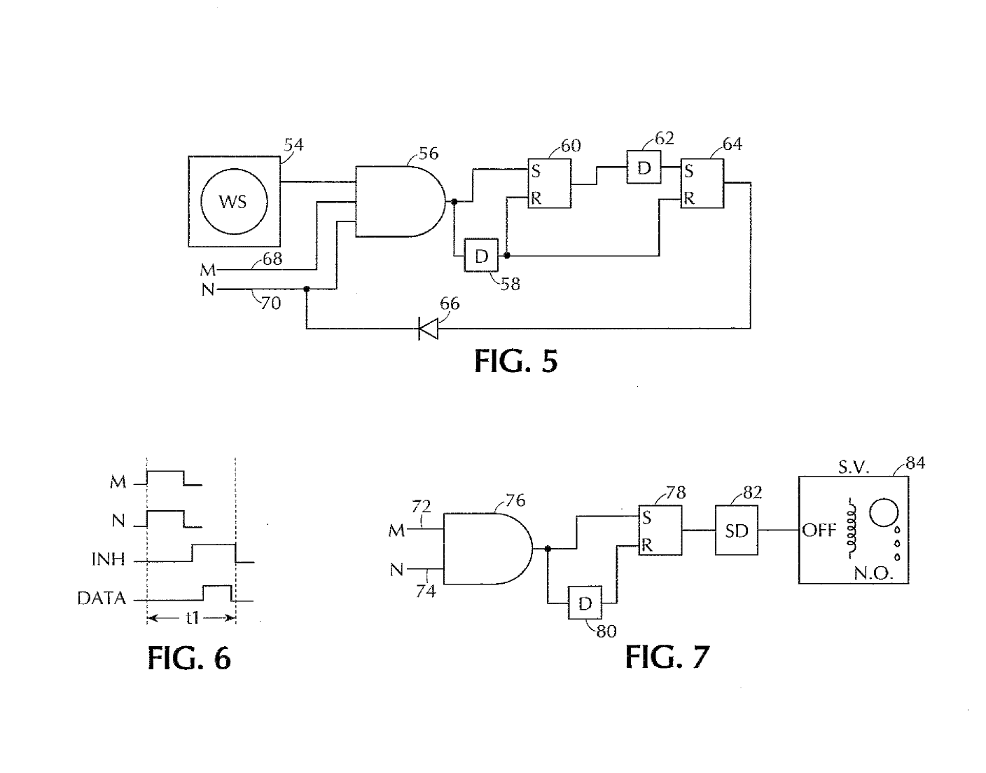

FIG. 5 shows a logic block diagram of each of the sensor floor tiles. A weight sensor 54 preferably using a force sensing resistor (such as Pololu part number 1696) with a threshold comparator returns a 0 or 1 logic level interpreted as directly sensing a visitor if a “1”. 3-way AND 56 has a 1 output level when addressed by M and N coordinate lines 68 and 70 respectively while weight sensor 54 outputs a “1”. This then sets latch 60 which starts DELAY block 62 setting latch 64 after a delay. DELAY block 58 of longer duration than DELAY block 62 then resets both latches. This forms a properly placed return data bit on the N address bus through blocking diode 66. The relational timing diagram for the address lines, inhibit signal and data return bit is shown in FIG. 6. Note the total duration is shown as t1. Note that the propagation delay of a signal in coaxial cable is approximately 0.2 ns per inch. For 40 feet of cable this amounts to about 100 ns or 0.1 microsecond. If we set a conservative t1=5 microseconds, then a polling sequence can be performed in 1600×5 microseconds or 8 milliseconds. This is the time for a visitor to travel approximately 0.6 inches at a walking speed of 6′/sec.

FIG. 7 is a logic block diagram of each of the ceiling water tiles. Two-way AND 76 accepts ceiling address lines 72 and 74 to select a tile for solenoid valve turnoff. Latch 78 is set and drives solenoid driver 82 which turns off normally open solenoid valve 84. The valve is kept off until the timeout of DELAY block 80 at which time it would revert to its normally open state of providing “rain” at the tile site, that is unless address M,N is again on the ceiling address bus retriggering DELAY block 80. Ceiling address bus signals are approximately 2 microseconds in duration while the delay of DELAY block 80 is about 20 milliseconds to insure enough time for retriggering thereby preventing short cycling (chatter) of solenoid valves.

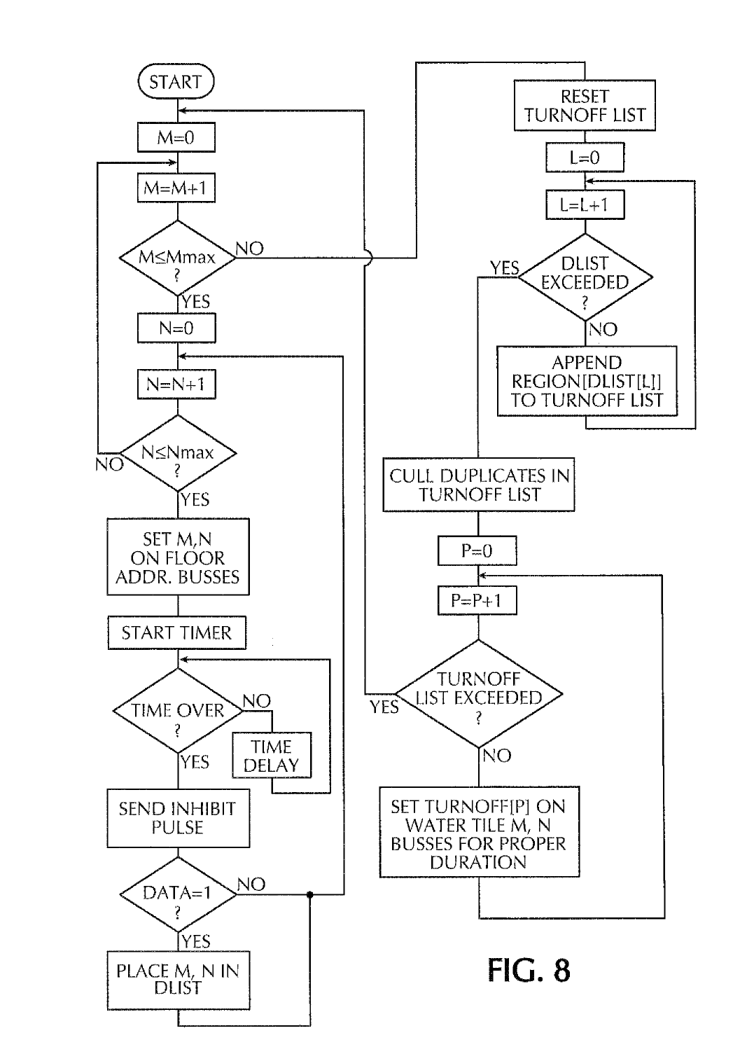

FIG. 8 is a flow chart of the control sequence for the first embodiment of this invention. The left half of the flow involves creation of the “detected list” by polling all of the sensor floor tiles and recording the coordinates of those with directly detected visitors above. Continuing on the right half of the flow, a “turnoff list” of coordinate pairs (addresses) is created. This involves going through the “detected list” and accessing the pre-created region list for each address in the “detected list” and appending the entries there (dry exclusion zone addresses) to create the turnoff list. When this is done, the turnoff list is compacted by culling out duplicate address entries. Then the variable sized turnoff list is used to place the addresses on the ceiling tile M and N address busses one at a time to turn off the appropriate ceiling tile solenoid valves.

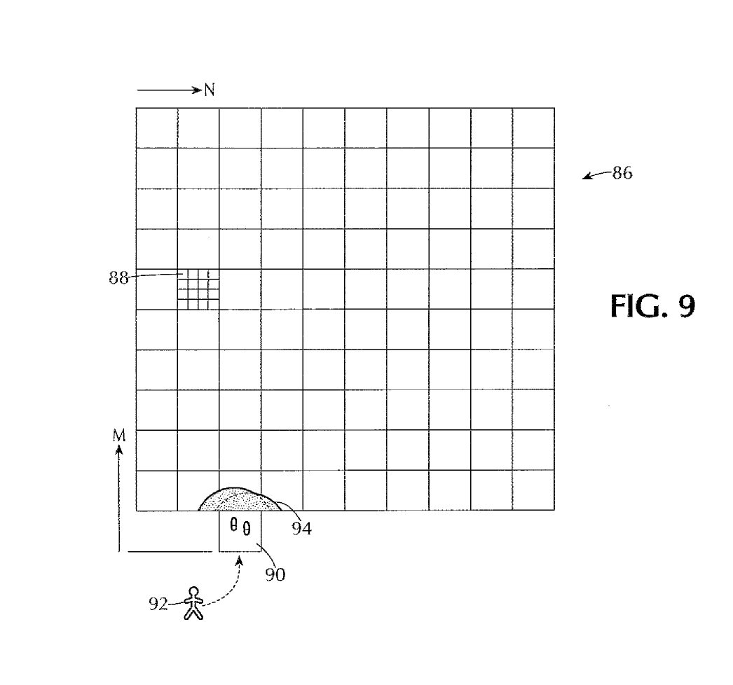

FIG. 9 shows a sensor floor arranged as adjacent 40″ by 40″ panels 86 each holding 16 sensor tiles as shown in the detail at 88. Also shown in this figure is the scheme to provide entry onto an SR floor in a natural fashion. This is achieved by extending the sensor floor by one panel (16 tiles) in the M direction beyond the active “rain” region. As a person 92 walks over this sensor floor extension 90 senses the visitor's feet directly and starts to form a dry zone 94 even before he or she enters the “rain” area. If M and N limits were a nominal 40 for a 1600 tile floor, the M coordinate limit is now simply extended to 44.

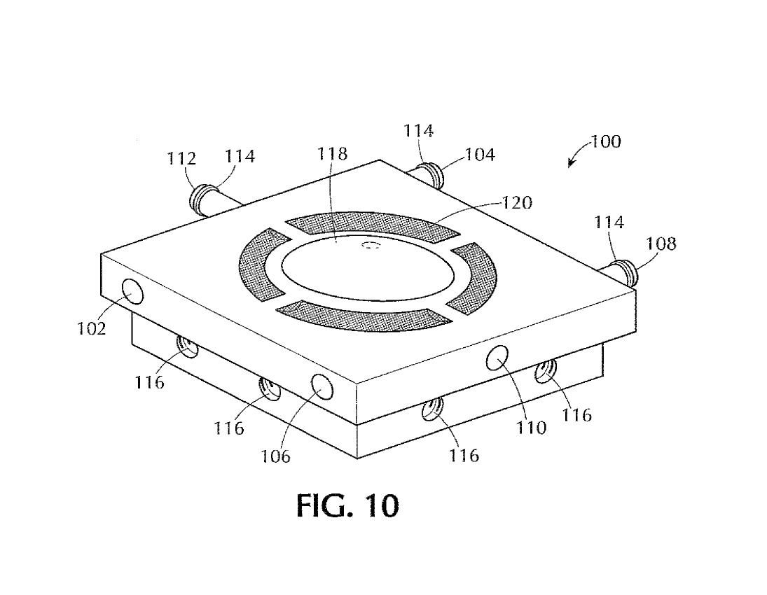

FIG. 10 shows a physical view of a sensor floor tile 100 with a slightly domed force sensing central area 118 surrounded by grooves 120 which allow water to flow through. These tiles 100 plug into each other on two orthogonal edge axes. The address M and N busses and power lines are created through coaxial connectors at the edges. The bottom portion is stepped down to permit connection to the edge of a square panel frame without interference with the plugability of tiles from one panel to an adjacent one. Threaded holes 116 permit attachment to these panel frames while they are unused on the more central tiles away from the edge of a panel. Hole 106 houses the female M bus connector while the male counterpart 108 extends from the opposite edge with O-ring 114 sealing the connection to the adjacent tile. Similarly, N bus is handled by pair 110 and 112, and power is handled by pair 102 and 104. Waterproof connectors such as R04 series from Connect Direct Sound Corporation can be used instead.

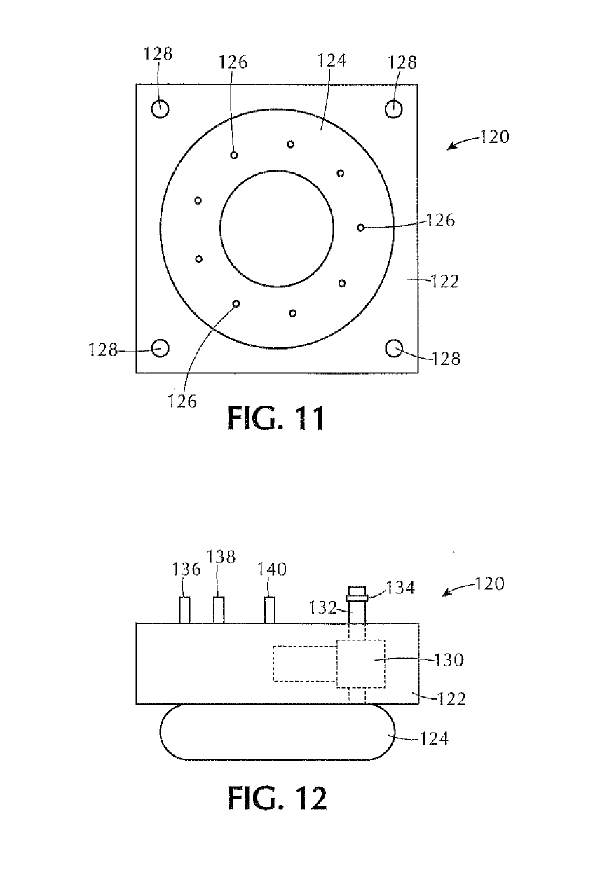

FIGS. 11 and 12 show the physical features of a ceiling water tile. A thick plastic resin housing 122 enclosing a solenoid valve 130 as well as electronics is shown with attached water-emitting head 124 in the form of a hollow torus. Solenoid valve 130 is incorporated into tile 100 to minimize the amount of water from the valve to the outlet nozzles 126 thereby limiting the chance of dripping from a closed valve tile. Tiles 100 are designed to plug into a lightweight rigid plastic panel and then securely screwed via holes 128. The water inlet is extension 132 sealed by o-ring 134. The M address bus line is at connector 136, the N address bus line is at connector 138, and power is at connector 140. Note that these connectors being away from direct water flow do not need to be waterproofed. The address and power busses are carried and distributed within the panels.

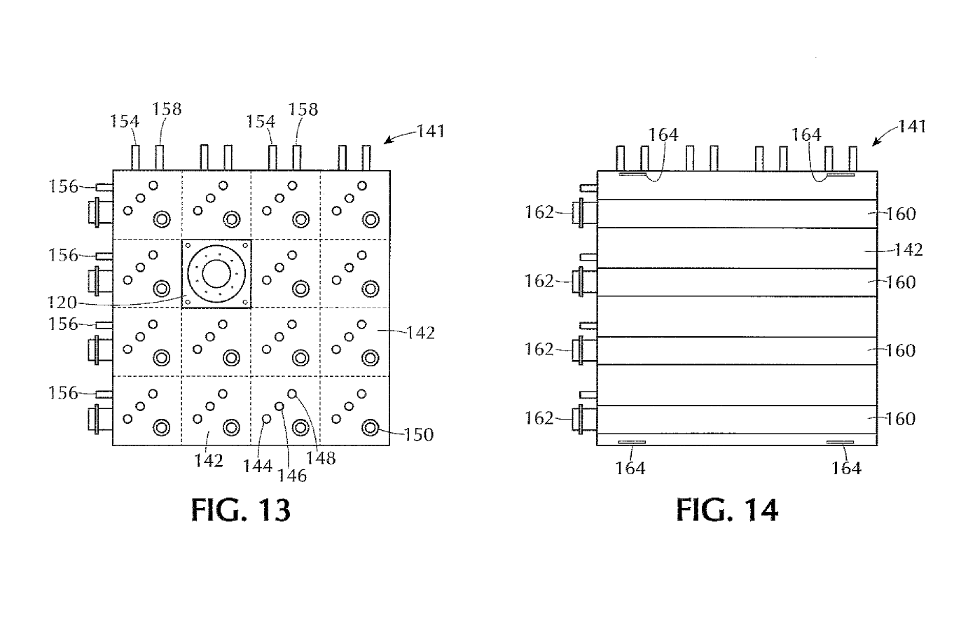

FIGS. 13 and 14 show the bottom surface view and the top surface view of the structural panel into which the ceiling tiles plug. The panel material itself should be lightweight and rigid. One choice is a closed cell rigid polyvinylchloride foam such as Sintra while another candidate material is a rigid honeycomb panel such as Nomex. FIG. 13 shows a panel 141 with the plug-in holes at each tile site 142; one water tile 120 is shown plugged in. The M address bus connector holes are at 144 and go to edge connectors 154. The power connector hole is at 148 while the panel edge connector is at 158. N address bus connector hole is at 146 with the edge connector at 156. Panel edge connectors 154 and 158 are attached to flexible extensions which retract into the panel to facilitate progressive interconnection of panels one at a time with connections at orthogonal edges. The top surface view shows four water distribution line segments 160 with end nipples and o-rings at 162. Each water line has four tap off nipples ending in water supply holes 150 which mate with solenoid connection extensions 132 for each ceiling water tile. Structural connection straps 164 attach each panel to structural beams above.

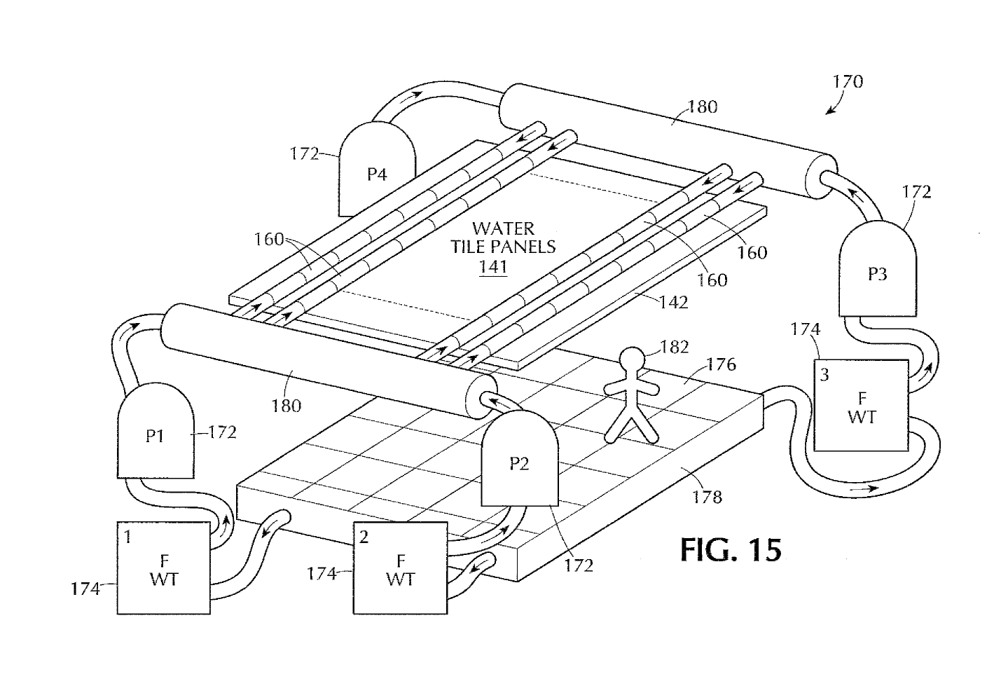

FIG. 15 shows a concept for balanced water distribution 170 for an SR room to minimize pressure variations at the ceiling tile nozzles from one corner of the room to the other. Four separate filter/water treatment modules 174 are used at the input side of four water pumps 172 respectively. The water treatment is preferably non chemical to prevent any odors emanating from the simulated rain as well as handling of noxious chemicals. Ozone generators or ultraviolet treatment methods to control pathogen growth are two techniques to be explored. Two manifolds 180 at ceiling height, at opposite sides or the room feed all of the segmented distribution pipes 160 attached to each ceiling tile panel 141. One pump 172 discharges into each end of each manifold 180. Manifolds 180 should be segmented to permit easy two-person handling and erection at each venue site. Floor 176 is perforated to permit water to fall through into holding catch basin 178 which feeds the pumps. A total of 500 to 800 gallons of water would be circulated for a typical SR room. Note that each distribution pipe 160 is pressurized from each end. Visitor 182 is shown for relative size and position. Power for the pumps may be utility provided in some venues. In other venues, power for the entire SR enclosure is easily provided by an engine driven generator as is often used for amusement rides. A DCA25US1 WhisperWatt Ultra Silent Generator in a towable soundproofed housing from MQ Multiquip Incorporated can supply 20 kW of 3 phase power at 220 volts.

Whereas the first embodiment relied on direct presence detectors integrated with sensor floor tiles and a computer to poll these locations to interpret and expand into commands for specific ceiling water tiles, this alternate embodiment takes a different approach enabled by integrating the direct presence detectors with each ceiling water tile. In fact, the floor is just a passive perforated floor.

The direct presence detectors are based on the use of distance sensors aimed directly down at each ceiling tile site. In the absence of a visitor under a detector, they would read the distance from ceiling to floor. When a visitor or part of one is under the sensor, a distance less than that is sensed. By adding a threshold and a comparator, the sensor information is converted into a binary output: presence (“1”) or no presence (“0”). For example, any reported distances foreshortened by over two feet would be considered a “1” output. These sensors can be ultrasonic such as an LV-Max Sonar-EZ3 from MaxBotix Inc. or infrared such as the GP2Y0A02YKOF analog distance sensor from Sharp Corp, Capacitive proximity sensors may also be of use.

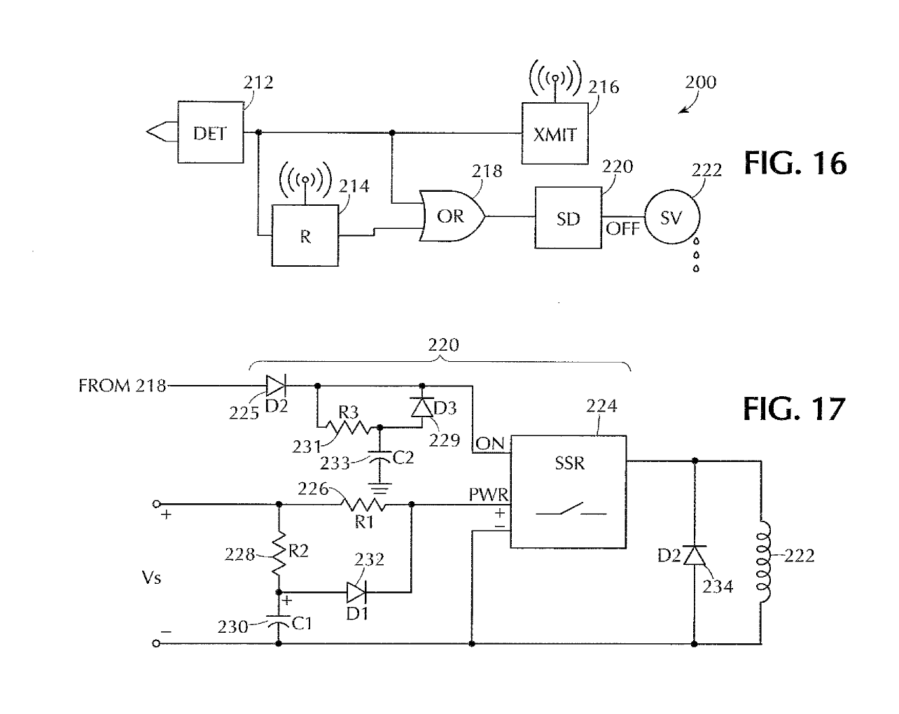

The control scheme for this embodiment is local; no central computer is required. FIG. 16 shows a block diagram of the technology integrated with each ceiling water tile. Two-way OR 218 enables solenoid driver 220 to turn off normally-on solenoid valve 222 to turn off the water output from the ceiling water tile if either direct presence detector 212 is activated or if a signal is received from a tile in the vicinity within the dry zone of another tile via receiver 214. A direct presence detection also starts local transmitter 216 and optionally inhibits the on-board receiver to protect it from a too powerful signal (if required). The local transmitter emits a signal that does not propagate beyond the desired dry zone radius of a tile detecting a visitor below.

FIG. 17 is a detail showing a drive circuit which can be used within solenoid driver 220. The intent is fast and secure turn-on of the solenoid via solid-state relay 224 and delayed turn-off of relay 224 once all visitors have moved away from the dry zone of this particular tile. The delayed turn-off of several milliseconds is to prevent valve chatter from one tile detection to the next as a visitor meanders in the SR room. To insure robust turn-on of the solenoid by supplying a high pulse of current to coil 222 (with snubber diode 234), the supplied voltage Vs is higher than the rated solenoid voltage. Resistor 228 charges electrolytic capacitor 230 to voltage Vs relatively slowly; resistor 226 reduces the current in coil 222 to above the holding current specified when Vs is applied through relay 224. However, at the instant when relay 224 is enabled, a spike of voltage from charged capacitor 230 bypasses dropping resistor 226 through diode 232 and causes a short spike of high current in coil 222 enough to insure reliable operation of solenoid 222 at start-up. Isolation diode 225, and resistor 231 supply slow charging current to charge capacitor 233 to the logic “1” level. When the output of OR 218 goes low, capacitor 233 will keep relay 224 on for several milliseconds through diode 229.

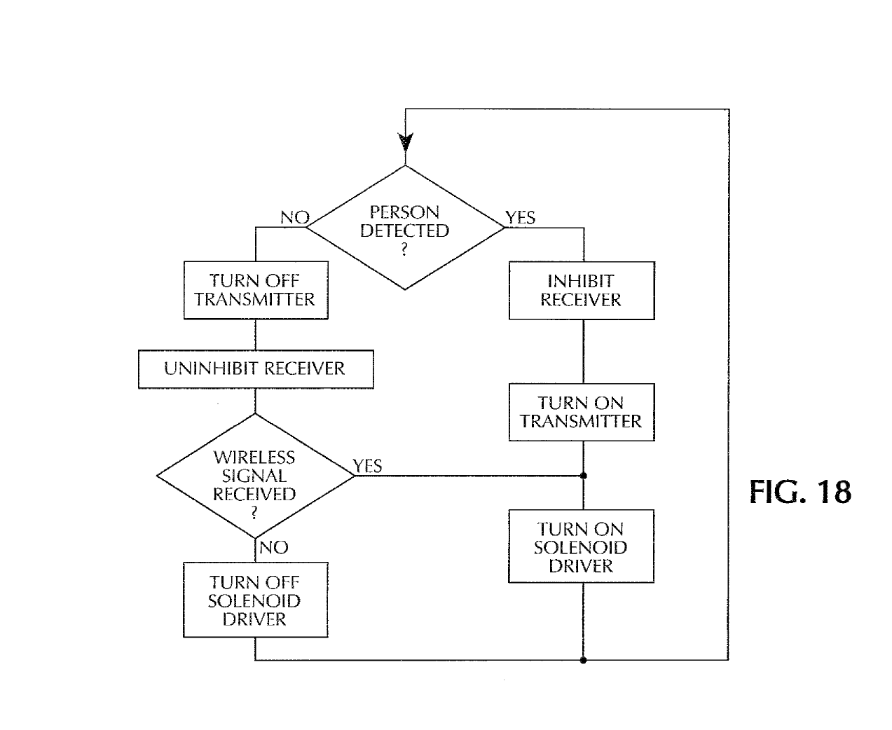

FIG. 18 is a flow chart explaining the operation of FIG. 16 in the manner of a high level programming flow chart. In fact, OR 218 can be replaced by an 8-bit microprocessor running this “code” continuously; it is possible, but hardly seems worth it!

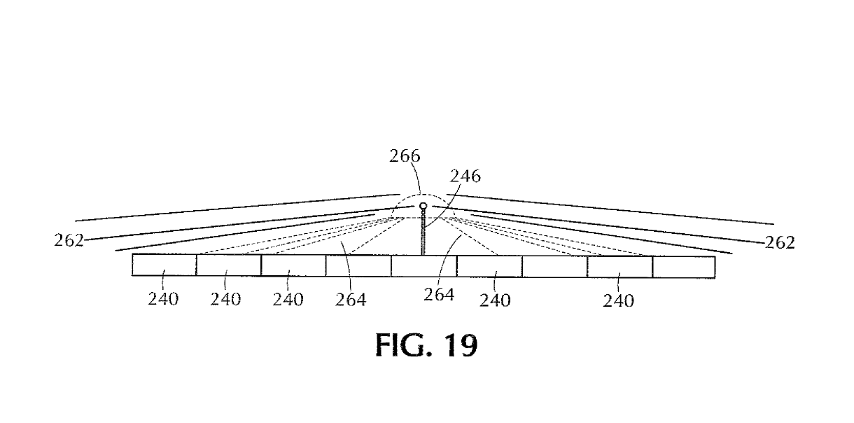

The challenge for proper operation of this embodiment is to insure enough transmit power to reach the edge of the desired dry zone, but not to send signals beyond. Note that although a whip antenna is shown in FIGS. 16 and 19, transmitter 216 and receiver 214 may be implemented as RF, IR, or ultrasonic devices where the latter types would not use an antenna. FIG. 19 shows a reflector 266 above antenna 246 (if used) to concentrate the emissions to those shown as 264 and prevent emissions 262 (without the use of reflector 266).

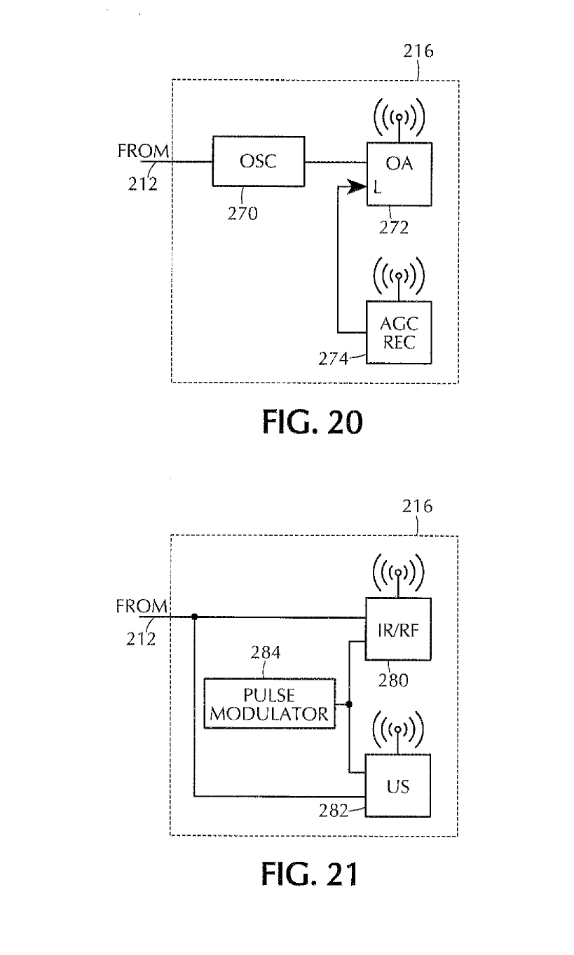

FIG. 20 shows an automatic gain (AGC) sampling receiver 274 which varies the level of the output amplifier 272 as a function of the actual locally received emissions. Oscillator 270 receives a start signal from direct presence detector 212 in FIG. 16. A carefully controlled output signal power is useful for calibrating the distance a signals travels. This constitutes a local feedback control system.

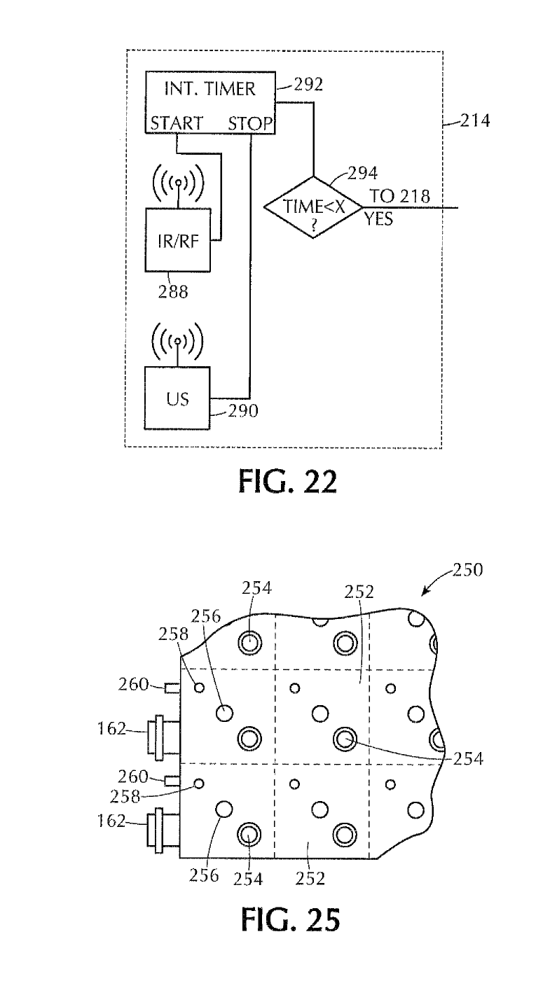

Besides signal strength, a Dual-Mode transmitter and receiver as in FIGS. 21 and 22 can be used to gauge distance from the transmitter at a remote receiver. In fact for this to work, the transmitted signals should be designed to travel a small distance beyond the desired dry zone radius. Either an IR or RF transmitter 280 is paired with an ultrasonic transmitter 282. Upon actuation, both transmitters are simultaneously modulated 284 by a short pulse that repeats every few milliseconds. Since the ultrasonic signal travels at the speed of sound, its signal would arrive at a remote receiver after the RF or IR signal. FIG. 22 shows that a received pulse at 288 would start an interval timer 292 while receiver 290 would receive the pulse later and stop timer 292. The time stored in timer 292 is then compared to a limit “x” in comparator 294. If the stored time is less than “x”, the solenoid valve at the remote ceiling tile site would turn off the tile's water flow. Note that an “x” of 3.9 milliseconds would insure a dry zone of 3.5 feet.

Note that the transmitter of FIG. 20 can be substituted for transmitter 216 in FIG. 16 as can the Dual-Mode transmitter of FIG. 21. The latter would require the Dual-Mode receiver of FIG. 22 be substituted for receiver 214 in FIG. 16.

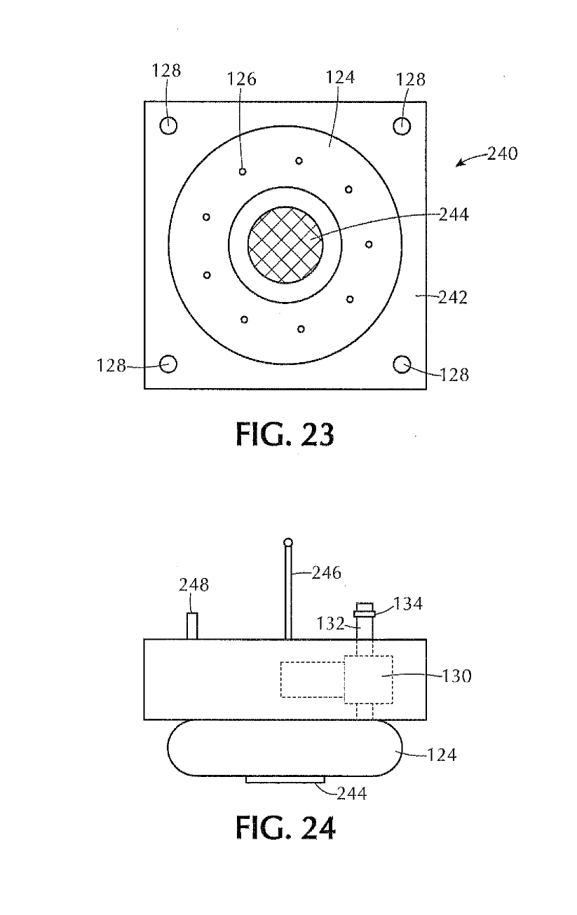

A physical ceiling water tile of second embodiment 240 of this invention is shown in FIGS. 23 and 24. It differs in appearance by the addition of a direct presence detector 244 in the center of water torus 124. In the side view of FIG. 24, a short whip antenna 246 is shown in case the wireless equipment is RF. No optional reflector is shown. Note also that only one electrical connector for power input 248 is required. FIG. 25 shows a small section of ceiling panel 250 with a few unoccupied ceiling tile sites 252 shown. Holes 258 and 254 are for power connector and water coupling respectively. Central through hole 256 is for a whip antenna or alternative IR or ultrasonic emitter/receiver. Note that the ceiling panel for this embodiment has protruding connections on only one edge, 260 and 162, thereby making ceiling panel assembly more simplified.

Note that a natural method of handling entry to the SR rain floor in the second embodiment is similar in concept to that shown in FIG. 9 of the first embodiment. An extra ceiling water panel is appended to the edge of the active ceiling water panels at the point of entry. A normal panel with 16 ceiling water tiles is used, but the water distribution lines of this extra panel are not connected. Thus the ceiling tiles with their on-board transmitters perform normally and start creating a dry zone as a visitor progresses under it on the way to the SR floor. Also, the balanced water distribution concept of FIG. 15 is also useful for this second embodiment as well.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A simulated rain enclosure (SRE) comprising
a room having a ceiling and a floor;
said ceiling Supporting a tightly packed two dimensional array of water ejecting ceiling tiles;
a direct presence detector associated with each said ceiling tile,
wherein the detection of one or more visitor persons under one or more of said ceiling tiles by said respective direct presence detectors turns off water flow from each said associated ceiling tile and to a defined region of said ceiling tiles adjacent to each said associated respective ceiling tiles,
further wherein water flow is returned from any said ceiling tile previously turned off but not currently in a respective defined region of said respective defined regions.

2. The simulated rain enclosure according to claim 1 further comprising an array of weight sensing floor tiles in registration with said water ejecting ceiling tiles above thereby each said weight sensing floor tile forming a respective direct presence detector associated with each respective ceiling tile located above each said floor tile below.

3. The simulated rain enclosure according to claim 2 further comprising
a computer with address busses capable of addressing each said sensor floor tile and each said ceiling tile;
a detected list which is initially empty;
said sensor floor address bus also capable of supplying condition data relative to direct presence detection of a visitor person from each said sensor floor tile;
further wherein each said sensor floor tile is polled by said computer in an address sequence accumulating the address coordinates of each respective floor tile detecting a respective visitor person in said detected list.

4. The simulated rain enclosure according to claim 3 further comprising
a turnoff list;
a predefined region list;
wherein said turnoff list is first reset and then built-up by first using each coordinate pair in said detected list to address the contents of said region list by successively appending said contents to said turnoff list and then culling duplicate coordinate pairs in said turnoff list, further wherein each said address coordinate entry in said turnoff list is successively sent on said ceiling tile address bus in succession, thereby operating a solenoid valve in each said ceiling tile addressed to turn off water flow for a preset time period.

5. The simulated rain enclosure according to claim 2 wherein each said weight sensing floor tile is preassembled into a panel of multiple said floor tiles and wherein each said water ejecting ceiling tile is preassembled into a panel of multiple said water ejecting ceiling tiles.

6. The simulated rain enclosure according to claim 1 wherein each said two dimensional array of water ejecting ceiling tiles having a respective direct presence detector being mounted at the center of each said respective ceiling tile, each said respective direct presence detector detecting visitor persons directly below and communicating with adjacent tiles in a said defined region via a transmitter and a receiver also co-located with each said respective ceiling tile, each said transmitter and receiver providing local control of water supply to each said respective ceiling tile.

7. The simulated rain enclosure according to claim 6 wherein said receiver and said transmitter utilize wireless communication consisting of the group consisting of at least one of ultrasonic, infrared, or radio frequency types of wireless communication.

8. The simulated rain enclosure according to claim 7 wherein control of each said respective defined region is by control of respective radiated power of said transmitter and a predetermined reception threshold of said receiver.

9. The simulated rain enclosure according to claim 8 wherein control of said radiated power of said transmitter is by direct feedback via an automatic gain control (AGC) receiving a signal from a signal sampling AGC receiver, all co-located on each said ceiling tile.

10. The simulated rain enclosure according to claim 6 wherein said transmitter and said receiver are Dual-Mode, transmitting and receiving respectively both in an ultrasonic mode as well as in an infrared or radio frequency mode;
further wherein both said modes of signal transmitted are modulated simultaneously by a pulse which, when received by said Dual Mode receiver at a remote ceiling tile, are skewed in time, the amount of said skew determining whether said receiver ceiling tile is within said defined region.

11. The simulated rain enclosure according to claim 6 wherein said respective ceiling tiles are preassembled into panels of multiple ceiling tiles.

12. The simulated rain enclosure according to claim 1 wherein water is supplied to said array of ceiling tiles in a balanced fashion via four pumps and two manifolds.

13. A simulated rain enclosure with dynamically controlled dry regions comprising:
a room having a ceiling and a floor;
said ceiling comprising tiles each having a nozzle generating simulated rain directed downwardly;
a valve for each ceiling tile for controlling operation of said nozzle;
said floor comprising tiles;
each floor tile sensing weight of a person thereon for closing a valve in ceiling tiles overhead for creating and maintaining a dry zone around said person;
a source of pressurized water for said ceiling tiles;
said floor tiles including openings to allow water to flow therethrough; and
a holding catch basis beneath said floor tiles for receiving said water.

14. The simulated rain enclosure of claim 13 in which said floor tiles are in direct registration with said ceiling tiles.

15. The simulated rain enclosure of claim 14 having a computer to poll said floor tiles to identify presence locations for controlling said valves in said ceiling tiles.

16. The simulated rain enclosure of claim 15 in which said valves are normally open solenoid controlled valves.

17. The simulated rain enclosure of claim 16 in which each floor tile has a force sensor for detecting the presence of a person.

18. The simulated rain enclosure of claim 17 in which said enclosure has a sensor floor extension adjacent to the rain area for sensing the presence of a person about to enter said rain area for establishing a dry zone in said rain area.

19. The simulated rain enclosure of claim 17 in which each floor tile has a domed force central area surrounded by grooves allowing water to drain through.

20. The simulated rain enclosure of claim 17 in which each ceiling tile comprises a housing containing said solenoid controlled valve with a water-emitting head in the form of a hollow torus.

21. The simulated rain enclosure of claim 17 having a balanced water distribution system for minimizing pressure variations at the ceiling tile nozzles from one corner of the enclosure to another corner of said enclosure.

22. The simulated rain enclosure of claim 21 having water treatment modules to prevent pathogen growth in the simulated rain.

23. A simulated rain enclosure with dynamically controlled dry regions comprising:
a room having a ceiling and a floor;
said ceiling comprising tiles each having a nozzle generating simulated rain directed downwardly;
a normally open valve for each ceiling tile for allowing flow of water through said nozzle;
each said ceiling tile having a direct presence detector aimed directly down for detecting the presence of a visitor for closing said valve, creating and maintaining a dry zone around said visitor;
said ceiling tiles further comprising a transmitter and a receiver;
a source of pressurized water for said ceiling tiles;
said floor including openings to allow water to flow therethrough; and
said enclosure lacking any central computer for operation of said nozzles.

24. The simulated rain enclosure of claim 23 having a threshold and comparator for producing a binary output, numeral one for presence of a visitor or zero for no presence.

25. The simulated rain enclosure of claim 23 in which said valve is solenoid controlled.

26. The simulated rain enclosure of claim 23 having a reflector to concentrate emissions from said transmitter.

27. The simulated rain enclosure of claim 23 in which in each ceiling tile the direct presence detector is in the center of a water torus.
